(19) United States
(12) Patent Application Publication
(10) Pub. No.: US 2024/0241289 A1
(43) Pub. Date: Jul. 18, 2024

(54) METALENS ARRAY AND DISPLAY DEVICE HAVING SAME

(71) Applicant: Chiun Mai Communication Systems, Inc., New Tipei (TW)

(72) Inventors: AMIR HASSAN FIROOZI, New Taipei (TW); CHEN-SHENG HSU, New Taipei (TW)

(21) Appl. No.: 18/385,717

(22) Filed: Oct. 31, 2023

Related U.S. Application Data
(60) Provisional application No. 63/533,510, filed on Aug. 18, 2023.
(60) Provisional application No. 63/470,167, filed on May 31, 2023.
(60) Provisional application No. 63/454,586, filed on Mar. 24, 2023.
(60) Provisional application No. 63/439,685, filed on Jan. 18, 2023.

(51) Int. Cl. G02B 1/00; B82Y 20/00; G02B 1/10; G02B 3/00; G02B 27/01

(52) U.S. Cl. CPC G02B 1/002; B82Y 20/00; G02B 1/10; G02B 3/0043; G02B 3/0068; G02B 27/0172; G02B 2207/101

(57) ABSTRACT

A metalens array and a display device are provided, the metalens array includes at least one optical transparent substrate; a plurality of nanostructures arranged on the at least one optical transparent substrate, the plurality of nanostructures defining one or more metalenses, the one or more metalenses arranged in a predetermined arrangement; and a thin film coating over the plurality of nanostructures.

### CROSS-REFERENCE TO RELATED APPLICATIONS

This application claims priority to U.S. provisional Application No. 63/454,586 filed on Mar. 24, 2023, U.S. provisional Application No. 63/439,685 filed on Jan. 18, 2023, U.S. provisional Application No. 63/470,167 filed on May 31, 2023, and U.S. provisional Application No. 63/533,510 filed on Aug. 18, 2023 in the United States Patent and Trademark Office (USPTO), the contents of which are incorporated by reference herein.

### FIELD

The subject matter herein generally relates to optics technology, and particularly to a metalens array and a display device.

### BACKGROUND

Augmented Reality (AR) is a display technology that integrates virtual information with the real world. That is, based on the real world observed by the human eye, the virtual image information projected by an electronic device is integrated. Traditionally head-mounted AR display devices usually include a camera for capturing images within the viewer's field of view, and project virtual image information to a preset position within the viewer's field of view according to the captured image.

In recent years, metalenses have attracted great attention due to their compactness, efficient performance and ability for mass production. Despite these advantages, commercializing metalenses has yet a long way to go. Thus, some challenges like, large-area patterning of nanostructures (cm-size), limited choices of material in the visible spectrum, precise and high-resolution fabrication need to be carefully studied. Moreover, high-aspect ratio dielectric metalenses are the most commonly used metasurfaces to manipulate the phase, amplitude, and polarization of light.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic diagram of an embodiment of a display device.

FIG. 2A illustrates a schematic diagram of an embodiment of this application of a configuration of a metalens array applying to a display device (without a polarizer).

FIG. 2B illustrates a schematic diagram of an embodiment of this application of a configuration of the metalens array applying to the display device (with a polarizer).

FIGS. 3A and 3B illustrates embodiments of side views and top views (for four metalenses) of the metalens array disclosed in FIGS. 2A and 2B.

FIGS. 4A and 4B illustrate embodiments of side views and top views (for one metalens or four metalenses) of the metalens array disclosed in FIGS. 2A and 2B.

FIGS. 5A, 5B, and 5C illustrate embodiments of a unit cell of a passive metalens of the metalens array of FIGS. 3A, 3B, 4A, and 4B.

FIGS. 6A, 6B, and 6C illustrate embodiments of a unit cell of a passive metalens of the metalens array of FIGS. 3A, 3B, 4A, and 4B.

FIGS. 7A, 7B, and 7C illustrate embodiments of a unit cell of a passive metalens of the metalens array of FIGS. 3A, 3B, 4A, and 4B.

FIGS. 8A, 8B, and 8C illustrate embodiments of a unit cell of a passive metalens of the metalens array of FIGS. 3A, 3B, 4A, and 4B.

FIGS. 9A, 9B, and 9C illustrate embodiments of a unit cell of a passive metalens of the metalens array of FIGS. 3A, 3B, 4A, and 4B.

FIGS. 10A-10F illustrate top views of the one nanostructure which can be an isotropic or anisotropic nanostructure.

FIGS. 11A-11D illustrate schematic diagrams of embodiments of nanofabrication processes.

FIGS. 12A and 12B illustrate embodiments of a unit cell of passive metalens of the metalens array including a nanostructure.

FIGS. 13A-13C illustrate the types of shapes of the unit-cell nanostructure of the metalens from a top view, in accordance with some embodiments of the present disclosure.

FIGS. 14A-14C illustrate schematic diagrams of embodiments of nanofabrication processes.

FIG. 15A illustrates a schematic diagram of an embodiment showing a primarily result of a transmission efficiency for blue, green, and red spectra of the nanostructures.

FIG. 15B illustrates a schematic diagram of an embodiment showing an intensity of light at focusing point for blue, green, and red color.

FIGS. 16A-16B, 17A-17B, 18A-18B, 19A-19B, and 20A-20B illustrate the unit-cell nanostructures of the metalens array arranged as one or more metalenses in different configurations, in accordance with some embodiment of the present disclosure.

FIG. 21 illustrates a schematic diagram of an embodiment showing a design of arrangement for an achromatic metalens.

FIG. 22 illustrates a schematic diagram of an embodiment showing another design of arrangement for an achromatic metalens.

### DETAILED DESCRIPTION

Implementations of the disclosure will now be described, by way of embodiments only, with reference to the drawings. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein are to provide a thorough understanding of the embodiments described herein but are not to be considered as limiting the scope of the embodiments.

Several definitions that apply throughout this disclosure will now be presented.

The term “coupled” is defined as connected, whether directly or indirectly through intervening components, and is not necessarily limited to physical connections. The term “substantially” is defined to be essentially conforming to the particular dimension, shape or other word that the term modifies, such that the component need not be exact. The term “comprising,” when utilized, means “including, but not necessarily limited to”, it specifically indicates open-ended inclusion or membership in the so-described combination, group, series, and the like.

Augmented Reality (AR) is a display technology that integrates virtual information with the real world. That is, based on the real world observed by the human eye, the virtual image information projected by an electronic device is integrated. Traditionally head-mounted AR display devices usually include an image capturing module and a display device for capturing images within the viewer's field of view, and project virtual image information to a preset position within the viewer's field of view according to the captured image.

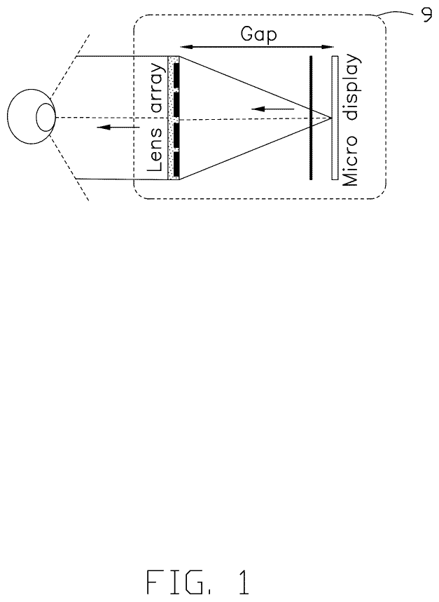

FIG. 1 illustrates a lens-array applied in a display device in conventional art. The display device 9 includes a micro display and a lens-array arranged from an image side to an object side, a gap or a distance is formed between the micro display and the lens-array. Lights emitted from the micro display can be transmitted through the lens-array to observer's eyes.

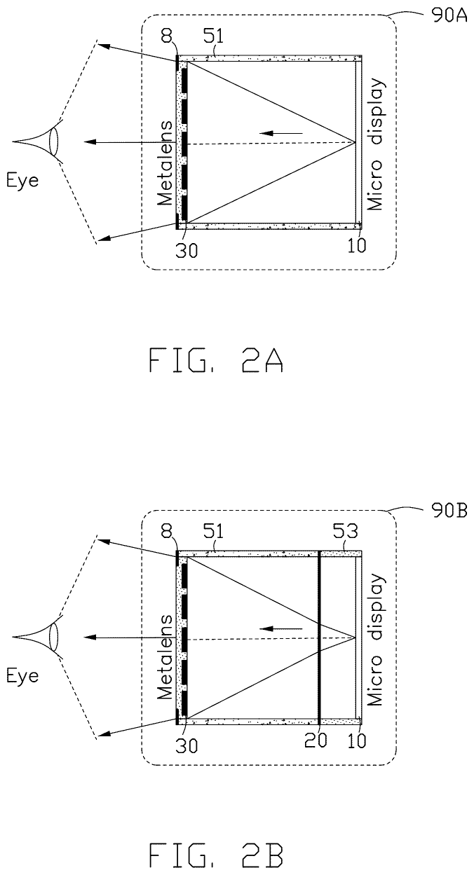

FIG. 2A illustrates one embodiment of a metalens array for delivering or displaying augmented reality (AR) or virtual reality (VR) or mixed reality (MR). The metalens array may be applied in a display device, such as an AR/VR/MR glasses. The display device 90A includes a micro display 10, a spacer 51, and a metalens array 30 arranged from an image side to an object side. The micro display 10 and the metalens array 30 are uniformly separated using the spacer 51. An aperture (stop) 8 is arranged on a side of the metalens array 30 that away from the micro display 10. One light is emitted from the micro display 10 and the micro display 10 displays a real image shown to the observer's eyes. However, depending on the design and the distance between the micro display 10 and the metalens array 30, a real or virtual image depends on the design can be formed. Light beam emitted from the micro display 10 may be restricted by the aperture 8. The light beam may be restricted by an aperture (stop) 8. In this embodiment, it is no need to use polarizer module (e.g., the polarizer module 20 shown in FIG. 2B) and the optically transparent glue (e.g., the optically transparent glue 53 shown in FIG. 2B) in the display device 90A. This scheme is used when isotropic nanostructures (41) are utilized.

FIG. 2B illustrates one embodiment of a configuration of the metalens array 30 applied in a display device 90B. In at least one embodiment, the display device 90B can also be an AR/VR/MR device, such as an AR/VR/MR glasses. The display device 90B includes a micro display 10, a space 53, a polarizer 20, a space 51, and a metalens array 30 arranged from an image side to an object side. An aperture (stop) 8 is arranged on a side of the metalens array 30 that away from the micro display 10. The spacer 53 is positioned between the micro display 10 and the polarizer 20, the space 51 is positioned between the polarizer 20 and the metalens array 30. In at least one embodiment, the polarizer 20 can be a linear polarizer, a circular polarizer, or a combination of a liner polarizer and a quarter-wave plate. In one embodiment, the polarizer 20 is the circular polarizer to circularly polarize the light emitted from the micro display 10. In another embodiment, the polarizer 20 is the linear polarizer or a combination of a liner polarizer and a quarter-wave plate to form a circular polarizer. In at least one embodiment, the polarizer 20 can be laminated to the micro display 10 using an optically transparent glue 53, that is, the spacer 53 can be formed by the optically transparent glue 53. Light beam emitted from the micro display 10 may be restricted by the aperture 8. This polarizer-dependent scheme is used when anisotropic nanostructures 41 are utilized and work based on geometrical-phase principle or other principles that enable 2π phase change to fully manipulate the light emitted from the micro display 10. In one embodiment, the display device 90A, 90B includes a micro display 10 and at least one metalens array 30. The micro display 10 is configured to emit lights. The at least one metalens array 30 is spaced apart from the micro display 10. The at least one metalens array 30 is configured to transmit the lights emitted by the micro display 10.

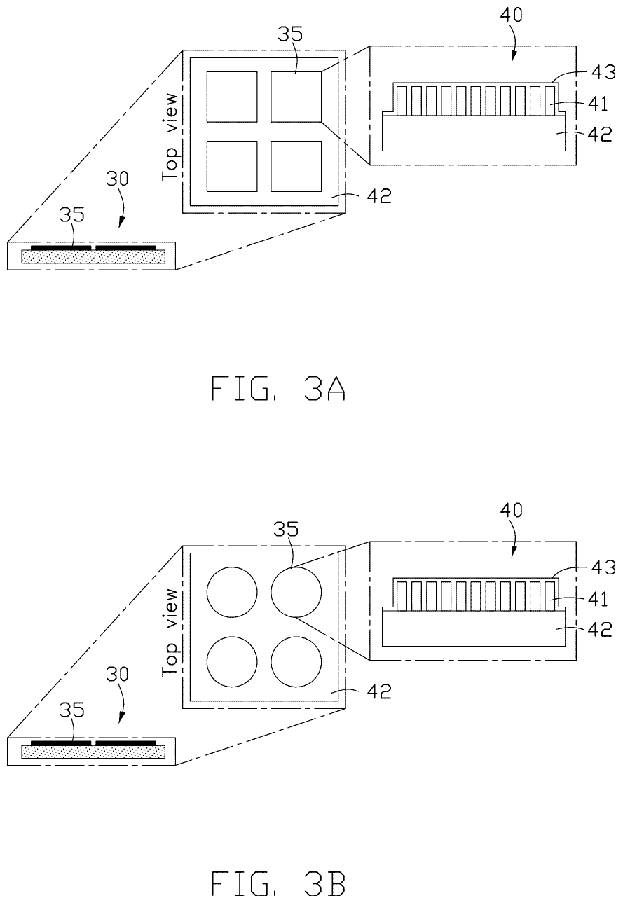

FIGS. 3A and 3B illustrates at least one embodiment of side views and top views (e.g., for four metalenses) of the metalens array 30 shown in FIGS. 2A and 2B. The metalens array 30 includes at least one optical transparent substrate 42 and a plurality of nanostructures 41. The optical transparent substrate 42 can be any type of transparent substrate, such as glass made of fused silica (SiO₂) or Sapphire or in a reflective element which can be made of silicon and other materials.

As shown in FIGS. 3A & 3B, a zone 40 is a zoom-in presentation of the one or more metalenses 35. The plurality of nanostructures 41 are arranged and fabricated on the optical transparent substrate 42. The plurality of nanostructures 41 are arranged to define or form one or more metalenses 35, such as four metalenses 35 as shown in FIGS. 3A and 3B, which are not limited by the present disclosure. The plurality of nanostructures 41 can also form a metasurface in the metalens array 30. In at least one embodiment, the plurality of nanostructures 41 can be arranged in any desired arrangements, such as a grid, rows and columns of a plurality of the metalens arrays 30. In at least one embodiment, the plurality of nanostructures 41 can be made from materials such as dielectric like curable resin, photoresist, and metal oxide nanoparticles and sol-gel mixture, etc. of different thicknesses ranging from 150 nanometers (nm) to a few thousand nanometers for nano pillars and thin deposition of metal oxides (TiO₂, Al₂O₃, HfO₂), or metal (like gold, silver, aluminum, etc.) from 10 nm to 70 nm, not limited only to these ranges. In at least one embodiment, the plurality of nanostructures 41 can be made from materials such as nanoimprinted resin.

In at least one embodiment, each metalens 35 of the metalens array 30 may be in different diameters. In at least one embodiment, an outline of each metalens 35 can be rectangular (shown in FIG. 3A), circular (shown in FIG. 3B) or any shapes depends on the shape of the display.

A thin film 43 is coating over the plurality of nanostructures 41. In at least one embodiment, the thin film 43 is conformally deposited on the patterned resin of the plurality of nanostructures 41 using an atomic layer deposition system. The thin film 43 can be made of TiO₂, Al₂O₃, HfO₂, etc. That is, in at least one embodiment, the thin film 43 has a conformal thickness that coating over the plurality of nanostructures 41. In other embodiment, the thin film 43 has a non-conformal thickness that coating over the plurality of nanostructures 41.

In at least one embodiment, materials of the plurality of nanostructures 41 are composed of dielectric (TiO₂, Al₂O₃, HfO₂), or metal (like gold, silver, aluminum, etc.) and nanoimprinted resin.

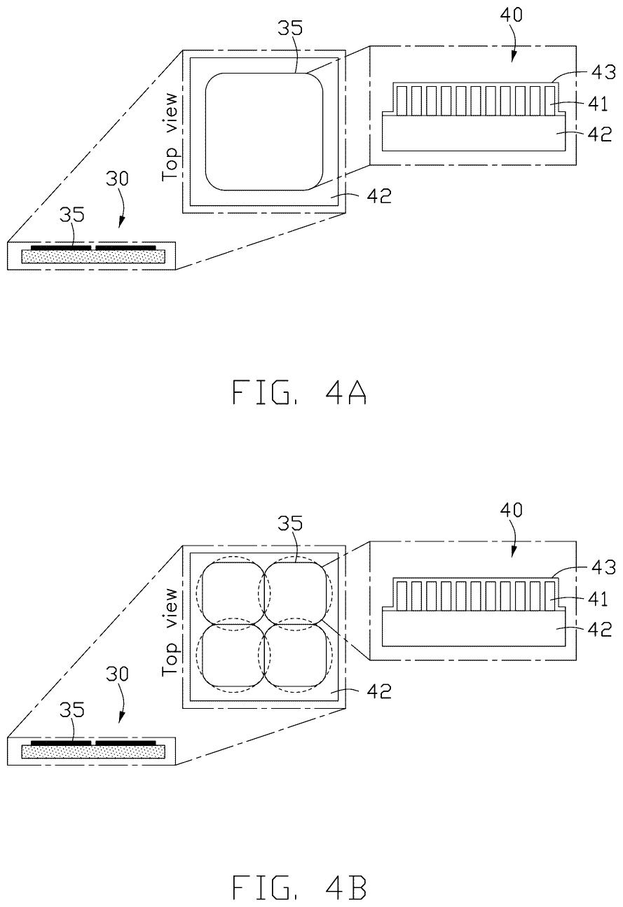

FIG. 4A illustrates at least one embodiment of a side view and a top view of a single lens of the metalens array 30 shown in FIG. 2A or 2B. As shown in FIG. 4A, the plurality of nanostructures 41 may form one signal metalens 35 with a greater size.

FIG. 4B illustrates at least one embodiment of a side view and a top view of a lens-array of the metalens array 30 shown in FIG. 2A or 2B. As shown in FIG. 4B, the plurality of nanostructures 41 may form a lens-array of the metalens array 30 including four metalenses 35. Every two adjacent metalenses 35 are partially overlapped, that is, edges of every two adjacent metalenses 35 are overlapped. In an embodiment, the one or more metalenses 35 are arranged in non-overlapping configuration as shown in FIGS. 3A, 3B, 4A. In another embodiment, the one or more metalenses 35 are arranged in overlapping configuration as shown in FIG. 4B.

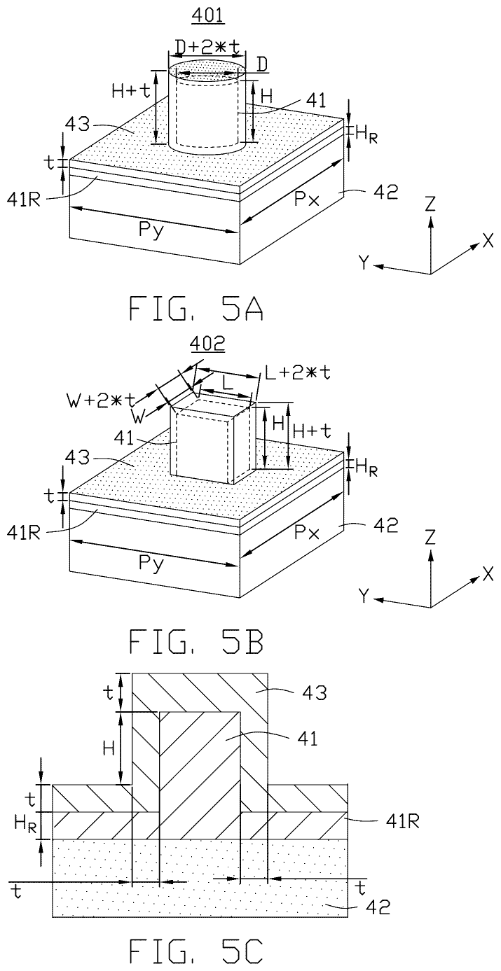

FIG. 5A illustrates at least one embodiment of a unit cell 401 of the metalens array 30 of FIGS. 3A, 3B and FIGS. 4A, 4B. The metalens array 30 can be divided into a plurality of unit cells such as the unit cell 401. As shown in FIG. 5A, the unit cell 401 includes a cylinder shape of the nanostructure 41. The unit cell 401 includes one nanostructure 41 with dimensions of inner diameter (resin's radius) D, outer diameter D+2*t (resin coated with high-index materials or the thin film 43), thickness of conformally deposited material t or thickness of deposited thin film t, resin (photoresist) height H, and H_{R} is a residual resin remained after nanoimprint which is labeled by 41R, or named as nanostructure layer 41R, the thin film material is labeled by 43. In at least one embodiment, the thin film 43 is evenly coating the nanostructure 41 and the nanostructure layer 41R, that is, the thickness of the thin film 43 is even as t shown in FIGS. 5A, 5B, 5C. The unit cell 401 includes one substrate 42 with a dimension of pitch Px (along x-direction), and pitch Py (along y-direction).

FIG. 5B illustrates at least one embodiment of a unit cell 402 of the metalens array 30 of FIGS. 3A, 3B and FIGS. 4A, 4B. The metalens array 30 can be divided into a plurality of unit cells such as the unit cell 402. As shown in FIG. 5B, the unit cell 402 includes a rectangular shape of the nanostructure 41. The unit cell 402 includes one nanostructure 42 with dimensions of inner width W, outer width W+2*t, inner length L, outer length L+2*t, resin (photoresist) height H, H_{R} is the residual resin remained after nanoimprint which is labeled by 41R, or named as nanostructure layer 41R. The unit cell 402 includes one substrate 42 with a dimension of pitch Px (along x-direction), and pitch Py (along y-direction). The thin film 43 is made of high-index refractive index like TiO₂, Al₂O₃, HfO₂ and it is conformally deposited on the patterned resin (nanostructure) 41 using an atomic layer deposition system.

FIG. 5C illustrates a cross-section view of the unit cell 401, 402 shown in FIG. 5A and FIG. 5B, showing details of dimension of the nanostructures 41, the substrate 42, and the thin film 43. As shown in FIG. 5C, t is thickness of the thin film 43, H is the height of the nanostructures 41, H_{R} is a thickness of the nanostructure layer 41R, the nanostructure 41 is disposed on the substrate 42.

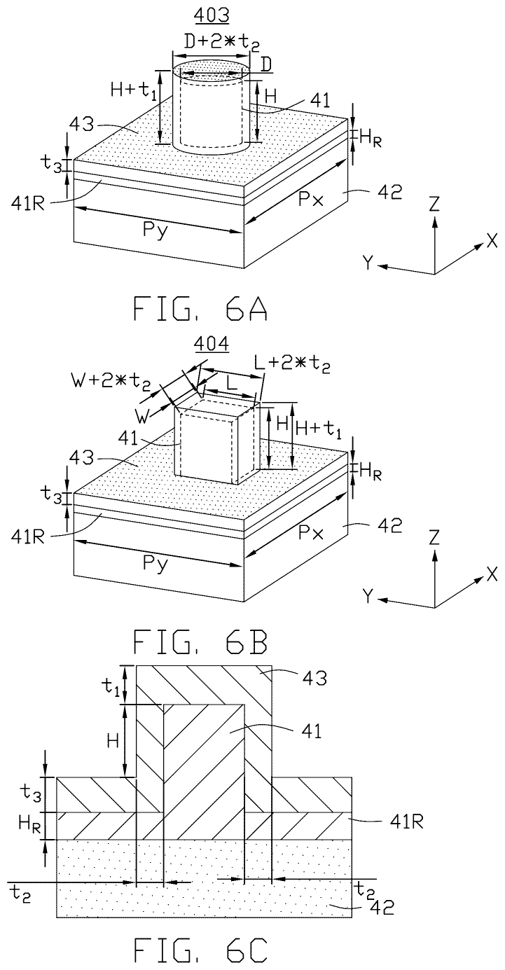

FIG. 6A illustrates one embodiment of a unit cell 403 of the metalens array 30 of FIGS. 3A, 3B and FIGS. 4A, 4B. FIG. 6A corresponds to FIG. 5A when the thickness of the thin film 43, which may be high-refractive index materials, is not uniform all over the nanostructure 41 made from resin or photoresist. t₁, t₂, and t₃ present a thickness of thin film 43 on top, side, and bottom of the nanostructure 41, respectively. In at least one embodiment, t₁, t₂, and t₃ are different to each other, that is t₁≠t₃≠t₂. In some other embodiment, t₁=t₃ ≠t₂. In some other embodiments, t₁=t₂≠t₃.

FIG. 6B illustrates at least one embodiment of a unit cell 404 of the metalens array 30 of FIGS. 3A, 3B and FIGS. 4A, 4B. FIG. 6B corresponds to FIG. 5B when the thickness of the thin film 43, which may be high-refractive index materials, is not uniform all over the nanostructure 41 made from resin or photoresist. t₁, t₂, and t₃ present a thickness of thin film 43 on top, side, and bottom of the nanostructure 41, respectively. In other words, t₁, t₂, and t₃ are different to each other, that is t₁≠t₃≠t₂.

FIG. 6C illustrates a cross-section view of the unit cell 403, 404 shown in FIG. 6A and FIG. 6B. FIG. 6C corresponds to FIG. 5C when the thickness of the thin film 43, which may be high-refractive index materials, is not uniform all over the nanostructure 41. In other words, t₁, t₂, and t₃ are different to each other, that is t₁≠t₃≠t₂.

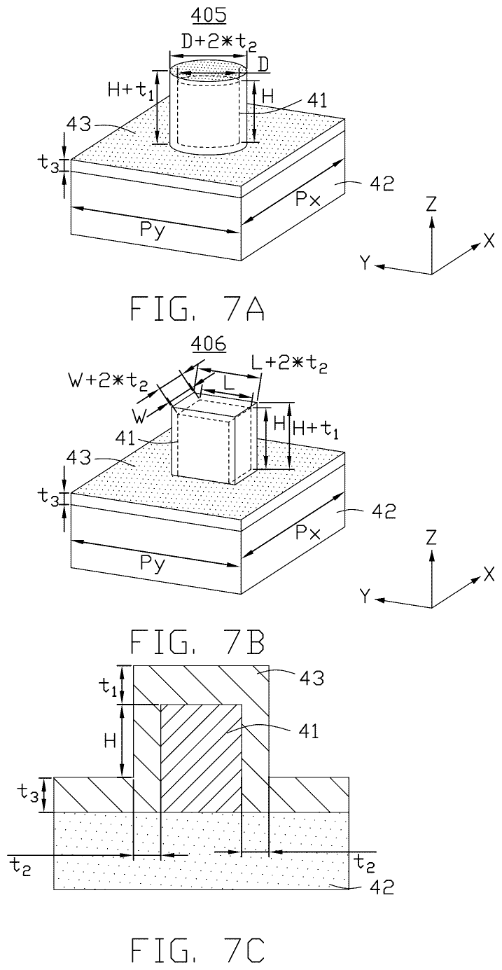

FIG. 7A illustrates at least one embodiment of a unit cell 405 of the metalens array 30 of FIGS. 3A, 3B and FIGS. 4A, 4B. The unit cell 405 includes a cylinder shape of the nanostructure 41. The unit cell 405 includes one nanostructure 41 with dimensions of inner diameter (resin's radius) D, outer diameter D+2*t₂ (resin coated with high-index materials or thin film 43), thickness of deposited material or thickness of deposited thin film 43 is not uniform all over the nanostructure 41. t₁, t₂, and t₃ present a thickness of thin film 43 on top, side, and bottom of the nanostructure 41, respectively, resin (photoresist) height H, there is no residual resin in this embodiment. The unit cell 405 includes one substrate 42 with a dimension of pitch Px (along x-direction) and pitch Py (along y-direction).

FIG. 7B illustrates at least one embodiment of a unit cell 406 of the metalens array 30 of FIGS. 3A, 3B and FIGS. 4A, 4B. The unit cell 406 includes a rectangular shape of the nanostructure 41. The unit cell 406 includes one nanostructure 41 with dimensions of inner width W, outer width W+2*t₂, inner length L, outer length L+2*t₂, resin (photoresist) height H, there is no residual resin in this case and one substrate 42 with a dimension of pitch Px (along x-direction), and pitch Py (along y-direction). The thin film 43 is made of high-index refractive index like TiO₂, Al₂O₃, HfO₂ and it is conformally deposited on the patterned resin (nanostructure) 41 using an atomic layer deposition system.

FIG. 7C illustrates a cross-section view of the unit cell 405, 406 shown in FIG. 7A and FIG. 7B, showing details of dimension of the nanostructures 41, the substrate 42, and the thin film 43. As shown in FIG. 7C, t₁, t₂, and t₃ present the thickness of thin film 43 on top, side, and bottom of 41, respectively, H is the height of the nanostructure 41, the plurality of nanostructures 41 are disposed on the substrate 42.

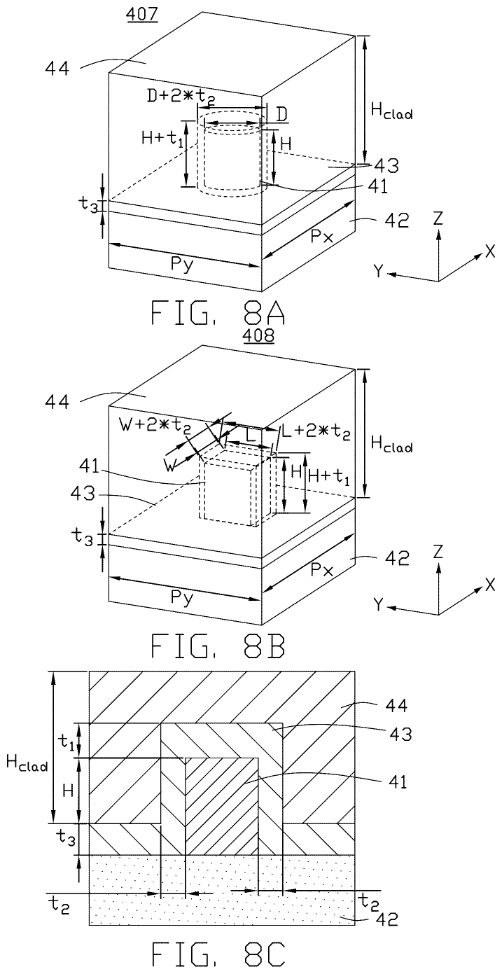

FIG. 8A illustrates at least one embodiment of a unit cell 407 of the metalens array 30 of FIGS. 3A, 3B and FIGS. 4A, 4B. FIG. 8A corresponds to FIG. 7A with only one difference and that is a cladding layer 44 with thickness of H_{clad}. The cladding layer 44 can be spin-coated (or deposited) over the thin film 43. The cladding layer 44 can be an impedance matching layer. A refractive index of the cladding layer 44 can be close to a refractive index of the substrate 42. The cladding layer 44 can be made from SiO₂, resin, photoresist, etc.

FIG. 8B illustrates at least one embodiment of a unit cell 408 of the metalens array 30 of FIGS. 3A, 3B and FIGS. 4A, 4B. FIG. 8B corresponds to FIG. 7B with only one difference and that is the cladding layer 44 with thickness of H_{clad}. The cladding layer 44 can be spin-coated (or deposited) over the thin film 43. The cladding layer 44 can be an impedance matching layer. The refractive index of the cladding layer 44 can be close to the refractive index of the substrate 42. The cladding layer 44 can be made from SiO₂, resin, photoresist, etc.

FIG. 8C corresponds to FIG. 7C with only one difference and that is the cladding layer 44 with thickness of H_{clad}. The cladding layer 44 can be spin-coated (or deposited) over the thin film 43. The cladding layer 44 can be an impedance matching layer. The refractive index of the cladding layer 44 can be close to the refractive index of the substrate 42. The cladding layer 44 can be made from SiO₂, resin, photoresist, etc. In at least one embodiment, the cladding layer 44 covers the thin film 43 as disclosed in FIGS. 5A-5B, 6A-6C, 7A-7C.

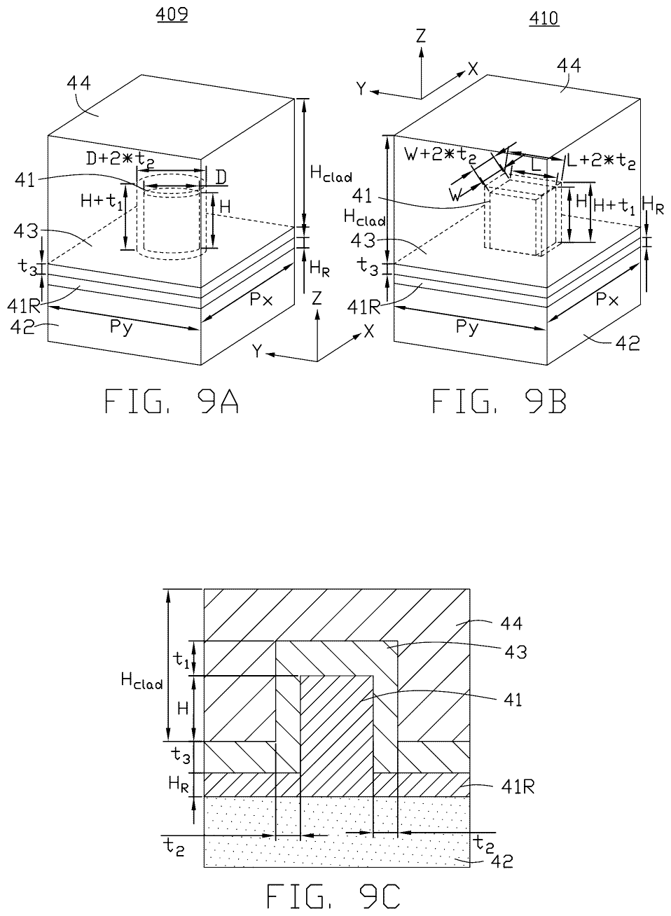

FIG. 9A illustrates at least one embodiment of a unit cell 409 of the metalens array 30 of FIGS. 3A, 3B and FIGS. 4A, 4B. FIG. 9A corresponds to FIG. 6A with only one difference and that is an impedance matching layer marked as a cladding layer 44 with thickness of H_{clad}. The refractive index of the cladding layer 44 could be close to the refractive index of the substrate 42. The cladding layer 44 can be spin-coated (or deposited) over the thin film 43. The cladding layer 44 can be made from SiO₂, resin, photoresist, etc.

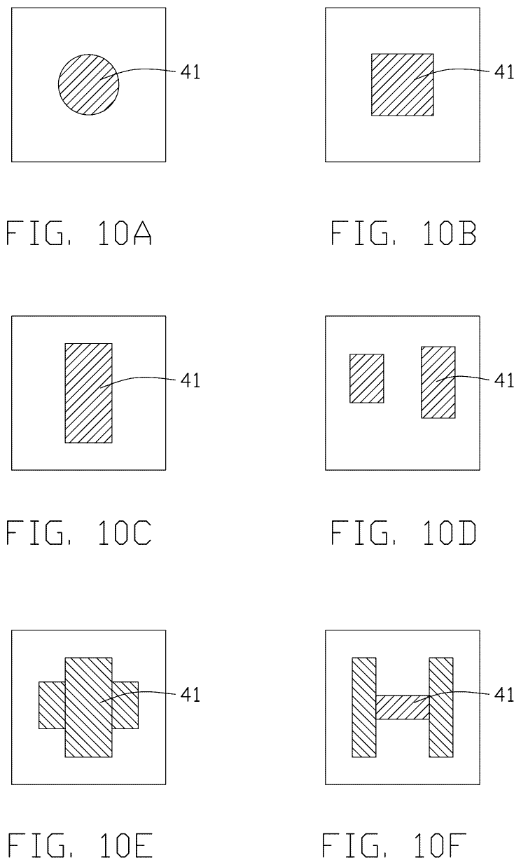

FIG. 9B illustrates one embodiment of a unit cell 410 of the metalens array 30 of FIG. 3 and FIG. 4. FIG. 10B corresponds to FIG. 6B with only one difference and that is an impedance matching layer marked as the cladding layer 44 with thickness of H_{clad}. The refractive index of the cladding layer 44 could be close to the refractive index of the substrate 42. The cladding layer 44 can be spin-coated (or deposited) over the thin film 43. The cladding layer 44 can be made from SiO₂, resin, photoresist, etc.

FIG. 9C corresponds to FIG. 6C with only one difference and that is an impedance matching layer marked as the cladding layer 44 with thickness of H_{clad}. The refractive index of the cladding layer 44 could be close to the refractive index of the substrate 42. The cladding layer 44 can be spin-coated (or deposited) over the thin film 43. The cladding layer 44 can be made from SiO₂, resin, photoresist, etc.

In one embodiment, the thin film 43 has a uniform thickness that coating over the plurality of nanostructures 41 as shown in FIGS. 5A-5C. In another embodiment, the thin film 43 has inconsistent thicknesses that coating over the plurality of nanostructures 41 as shown in FIGS. 6A-6C, 7A-7C, 8A-8C, and 9A-9C.

It should be known that, FIGS. 5A, 5B, 5C, 6A, 6B, 6C, 7A, 7B, 7C, 8A, 8B, 8C, 9A, 9B, and 9C may illustrate at least one cell of a passive metalens of the metalens array 30 of FIGS. 3A, 3B, 4A, and 4B, there should be a plurality of unit cells (such as the unit cells 401, 402, 403, 404, 405, 406, 407, 408, 409, 410 as shown in FIGS. 5A, 5B, 5C, 6A, 6B, 6C, 7A, 7B, 7C, 8A, 8B, 8C, 9A, 9B, and 9C) forming the metalens 35, and there are a plurality of metalens 35 forming the metalens array 30; or the metalens array 30 is formed by arranging a plurality of metalens 35, and each metalens 35 is formed by arranging a plurality of unit cells (such as the unit cells 401, 402, 403, 404, 405, 406, 407, 408, 409, 410 as shown in FIGS. 5A, 5B, 5C, 6A, 6B, 6C, 7A, 7B, 7C, 8A, 8B, 8C, 9A, 9B, and 9C).

In some embodiments, the unit cells of the metalens array 30 may be in a same size or in different sizes. For example, three or more different unit cells may be used, because different pitch, width, length is required for each color but the same height for all colors. However, in some special embodiments, the same unit cell (the same pitch) for all colors (with different widths and lengths, but the same height) can be used.

In at least one embodiment, a transparent rate of the thin film 43 is greater than a transparent rate of the plurality of nanostructures 41.

The plurality of the nanostructures 41 could be formed in different isotropic, anisotropic, or a combination of isotropic and anisotropic shapes depending on the desired spectrum of light and degree of phase and amplitude modulations. FIGS. 10A-10F shows some embodiments of top views of the plurality of the nanostructures 41 in different types or in different cross shapes. FIGS. 10A˜-10F shows the different shape types in the cross-section of the unit cell in FIG. 5A, FIG. 5B, FIG. 6A, FIG. 6B, FIG. 7A, FIG. 7B, FIG. 8A, FIG. 8B, FIG. 9A, FIG. 9B. Each of the plurality of the nanostructures 41 can be substantially circular shown in FIG. 10A, triangular, square shown in FIG. 10B, rectangular shown in FIG. 10C, or have an anisotropic shape shown in FIG. 10D, FIG. 10E and FIG. 10F. One of the pluralities of the nanostructures 41 is circular in shape shown in FIG. 5A, 6A, 7A, 8A, 9A, according to one embodiment. In other embodiments, each of the plurality of the nanostructures 41 can be in other shapes, such as “L” shape or “H” shape, not limited by the present disclosure. Each of the plurality of the nanostructures 41 is separated from each other by a pitch size in X direction of Px, which is from 150 nm to 700 nm, and a pitch size in Y direction of Py, which is from 150 nm to 700 nm. The pitch defines in two ways, either center-to-center of two adjacent nanostructures or edge-to-edge of two adjacent nanostructures. Each of the plurality of the unit cell nanostructures 41 can have a diameter of D, which is from 40 nm to 500 nm. Each of the plurality of the unit-cell nanostructures 41 can have a height of H, which is from 150 nm to 3000 nm. However, these values can be different for anisotropic nanostructures.

For example, the isotropic shapes can be circular shape, square shape with the same size no matter from which side to look at them. For example, the anisotropic shapes can be rectangular shape, “L” shape, “H” shape or any shape with different sizes from different sides to look at them.

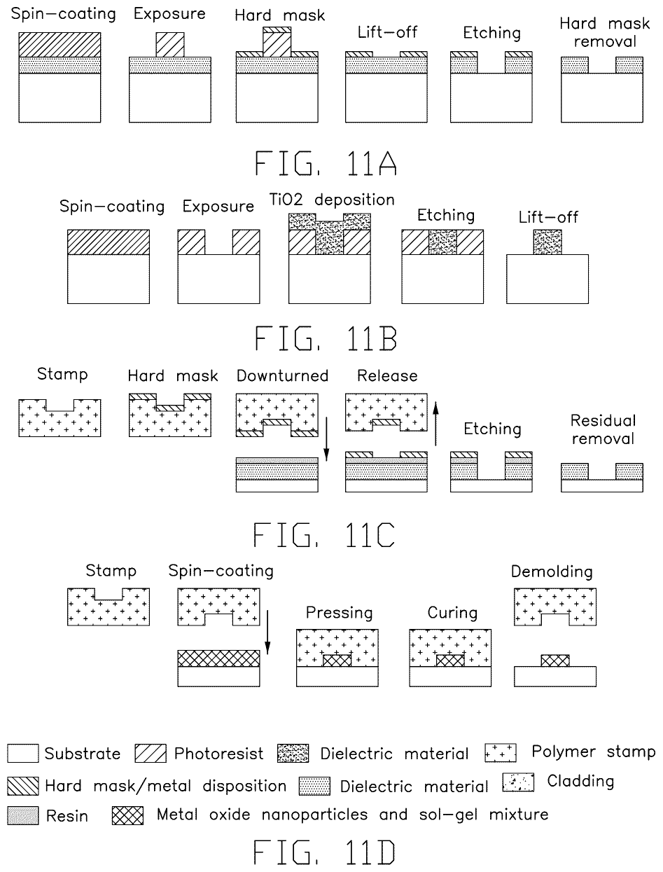

FIG. 11A illustrates a schematic of the nanofabrication process for EBL which requires hard mask deposition and etching. The fabrication order from left to right respectively is:
Step 1: depositing a high-refractive index dielectric material (TiO₂, GaN, SiN, Si, etc.) (the middle layer as shown in spin-coating step) on a transparent wafer as labeled as the substrate 42 in FIGS. 3A-3B, 4A-4B, 5A-5C, 6A-6C, 7A-7C, 8A-8C, and 9A-9C (like fused silica and sapphire);
Step 2: a thin layer of adhesive film (not shown here), a layer of photo-resist which is the top layer as shown in spin-coating step, and then a final layer of conductive polymer to avoid charging issue during the following EBL process are coated (not shown here);
Exposure step: The topmost layer is exposed using a high-accelerating voltage EBL to create the metalens which followed by removal of the conductive polymer layer in deionized water and development of exposed resist in a compatible photo-resist developer, respectively;
Hard mask step: a relatively thin film of metal (Nickel, chromium, etc.) is deposited onto the developed photo-resist as a hard mask;
Lift-off step: the photo-resist is then removed using photo-resist solvent (Acetone, Remover PG, etc.);
Etching step: the high-refractive index dielectric material is then etched using reactive ion etching;
Hard mask removal step: in the final step, the hard mask layer is dissolved in an acid-based solution and only the patterned dielectric nanostructures remained.

FIG. 11B illustrates a schematic of the nanofabrication process using EBL, DUV, and EUV. Which requires a thick high-quality atomic deposition layer is required. The fabrication order from left to right respectively is:
Step 1: a thin layer of adhesive film (not shown here), a layer of photo-resist which is the top layer as shown in spin-coating step, and then a final layer of conductive polymer to avoid charging issue during the following EBL process are coated (not shown here) are coated on a transparent wafer as labeled as the substrate 42 in FIGS. 3A-3B, 4A-4B, 5A-5C, 6A-6C, 7A-7C, 8A-8C, and 9A-9C (like fused silica and sapphire);
Exposure step: The topmost layer is exposed using a high-accelerating voltage EBL, or DUV or EUV to create the metalens which followed by (removal of the conductive polymer layer in deionized water in case of using EBL) development of exposed resist in a compatible photo-resist developer, respectively;
Deposition step: Next, a thin film of high-refractive index material like TiO2, Al2O3, HfO2, etc. is conformally deposited onto the developed resin using low-temperature atomic layer deposition (LTALD). The thin film is thoroughly deposited all over the patterned photo-resist nanostructures until it can utterly fill the gap between them;
Etching step: The extra grown TiO₂ film is eventually removed utilizing reactive ion etching with appropriate etchant gases until the underlying photo-resist layer is appeared;
Lift-off step: Finally, the photo-resist is removed in a photo-resist solvent (Acetone, Remover PG, etc.).

FIG. 11C illustrates a schematic of the nanofabrication process for a typical NIL including a hard mask deposition and etching. The fabrication order from left to right respectively is:
Stamp step: Master stamp is fabricated on a silicon substrate using a high-accelerating voltage EBL and a working stamp is then prepared, which is a replica of the master stamp when a high modulus silicone elastomer film is cast onto the master stamp, thermally cured, and placed face down into a thermally curable silicone elastomer with a glass in the back;
Hard mask step: a hard mask which can be a single-layer or a multi-layer (not shown here) such as Au, Cr and SiO₂ are deposited on the working stamp at high vacuum condition;
Downturned step: the hard mask is transferred on a transparent wafer (like fused silica and sapphire) with spin-coated adhesive layer on the top of a high-index material like TiO₂ (or GaN, poly-crystalline silicon, etc.);
Release step: Once, the hard mask is transferred to the substrate, the Cr layer is utilized to etch TiO₂ layer and the working stamp is released;
Etching step: Etching the TiO₂ continues until the transparent substrate is exposed;
Residual removal step: After the etching process, the Cr is removed using chromium etchant. Eventually, the residual layers above the TiO₂ metalens are dissolved by etching solution.

FIG. 11D illustrates a schematic of the nanofabrication process for a direct NIL using a metal oxide nanoparticles and sol-gel mixture instead of the resin. The replica of the master mold can be prepared using hard-PDMS (h-PMDS) or a water-soluble polymer like polyvinyl alcohol (PVA).

The fabrication order from left to right respectively is:
Stamp step: Master stamp is fabricated on a silicon substrate using a high-accelerating voltage EBL and a working stamp is then prepared, which is a replica of the master stamp when a high modulus silicone elastomer film is cast onto the master stamp, thermally cured, and placed face down into a thermally curable silicone elastomer with a glass in the back;
Spin-coating step: an inorganic film using metal oxide nanoparticle-based ink such as TiO2-based nanoparticle ink is spin-coated on the transparent substrate like glass or sapphire;
Pressing step: the working stamp is placed and pressurized on the spin-coated wafer;
Curing step: the film inside the holes and grooves of the working stamp is UV curved;
Demolding step: Finally, the working stamp is released (demolded) and the solidified nanostructures are formed.

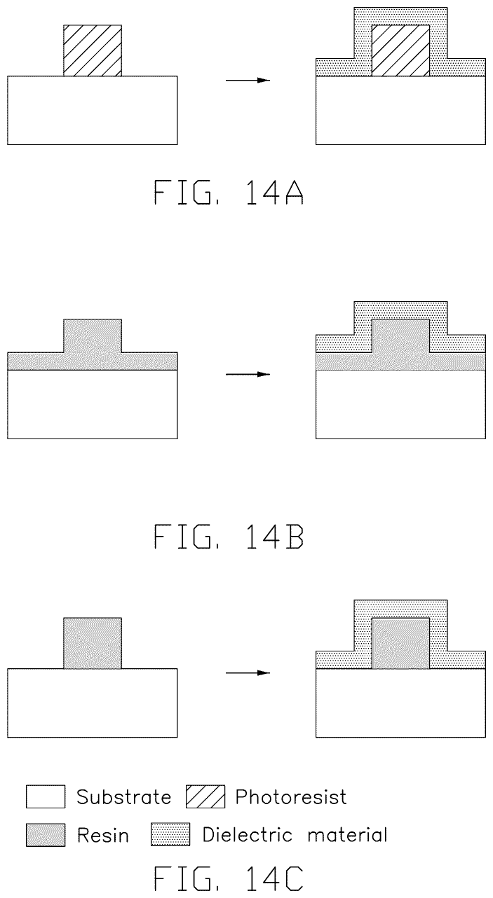

The below table illustrates the common and new nanofabrication techniques. In the table below pros and cons of these methods are given. Each of these techniques has addressed one or two issues but still caused other issues therefore, there is a need for a new nanofabrication process in which the cost, time, facile fabrication, and efficiency of the metalens are all together addressed. Here we proposed a new nanofabrication technique as shown in FIG. 14. once the working stamp is released a thin deposition of high-index dielectric (TiO₂, Al₂O₃, HfO₂), or metal (like gold, silver, aluminum, etc.) from 10 nm to 70 nm is required. It's noted that for deposition of the high-index dielectric materials, atomic layer deposition is preferable.

| | Pros | Cons |
|---|---|---|
| FIG. 11A | EBL enables high-resolution | Side-wall tapering due to the |
| | fabrication | etching |
| | Mediocre efficiency | Costly |
| | | Time-consuming |
| | | Patterning area is small |
| FIG. 11B | Near perfect side-wall without | Precise control of etching is |
| | tapering | required and etching needs to |
| | High efficiency | stop right after reaching to the |
| | | photoresist |
| | | Costly |
| | | Thick layer of |
| | | TiO₂ (>200 nm) |
| | | using atomic layer |
| | | deposition is |
| | | costly and time-consuming |
| FIG. 11C | Inexpensive | Etching causes side-wall |
| | Mass producible | tapering |
| | Mediocre efficiency | Substrate must have the high- |
| | | refractive index material |
| | | deposited prior to the process |
| | | Depends on the type of high- |
| | | index material a more |
| | | sophisticated hard |
| | | mask (multi- |
| | | layer) is required |
| FIG. 11D | Inexpensive | A careful mixture |
| | Relatively simple process | of metal oxide |
| | Mediocre efficiency | nanoparticles and sol-gel is |
| | | required |
| | | The resin mixture is not a |
| | | common process in |
| | | nanofabrication foundries |

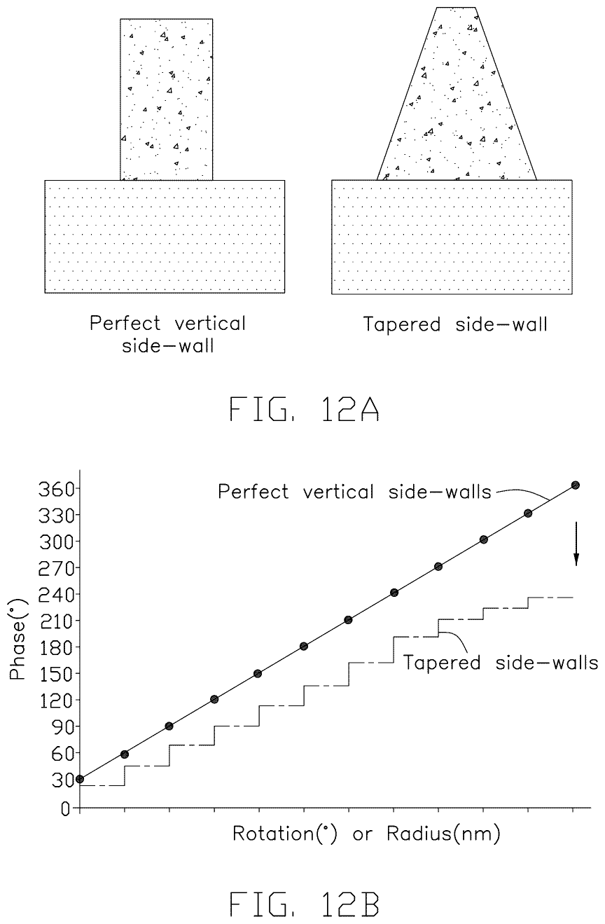

FIG. 12A shows a unit cell including a nanostructure with perfect side-wall (shown in a left in FIG. 12A) and with tapering side-wall (shown in a right in FIG. 12A). As shown in FIG. 12A, the side-wall of the nanostructure is tapered. A supercell including several nanostructures that together provide required phase to manipulate the light properties like polarization and amplitude. It cannot fulfill the required phase ramp to take full control of the incident light therefore the efficiency drops significantly.

FIG. 12B shows how a tapered nanostructure cannot fulfil required phase coverage (27) to fully manipulate light. The supercell with ideal side-walls can fully satisfies 27L phase change and consequently retains the efficiency high.

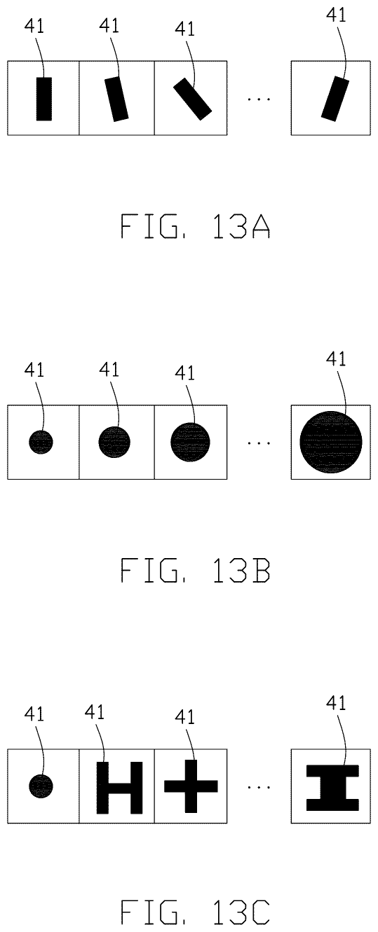

FIGS. 13A-13C illustrate the types of shapes of the unit-cell nanostructure of the metalens from a top view. FIG. 13A illustrates a schematic of the Pancharatnam-Berry (PB) phase or geometric phase which requires anisotropic nanostructures. The plurality of unit-cell nanostructures shown in FIG. 13A have a fully anisotropic shape and can be polarizer dependent. For example, the anisotropic shapes can be rectangular shape, “L” shape, “H” shape or any shape with different sizes from different sides to look at them. As shown in FIG. 13A, the shape in darker color are plurality of anisotropic nanostructures. Each square shape indicates one unit cell of the nanostructure 41 as shown in FIG. 10. In some embodiment, the plurality of nanostructures 41 shown in FIG. 13A can be disposed on the substrate 42.

FIG. 13B illustrates a schematic of a propagation phase with isotropic nanostructures of different sizes. The plurality of unit-cell nanostructures in FIG. 13B have a fully isotropic shape and can be polarizer independent. For example, the isotropic shapes can be any isotropic shapes like circular shape, square shape with the same size no matter from which side to look at them. The shape in darker color are plurality of isotropic nanostructures. Each circle shape means one unit cell of the nanostructure 41 as shown in FIG. 10. In some embodiment, the plurality of nanostructures 41 shown in FIG. 13B can be disposed on the substrate 42.

FIG. 13C illustrates a generalized form of the propagation phase and the PB-phase combination design using a dispersion engineered library of different nanostructure shapes. In some embodiment, the plurality of nanostructures 41 shown in FIG. 13C can be disposed on the substrate 42. The plurality of unit-cell nanostructures shown in FIG. 13C are in shape of a combination of the above types (i.e., a combination of an isotropic shape and an anisotropic shape), and the plurality of unit-cell nanostructures can be polarizer dependent.

In one embodiment, the plurality of nanostructures 41 are in a same shape but in different arrangement, such as shown in FIG. 13A. In one embodiment, the plurality of nanostructures 41 are in a same shape but with different size, such as shown in FIG. 13B. In another embodiment, the plurality of nanostructures 41 are in different shapes and different sizes, such as shown in FIG. 13C.

FIG. 14A illustrates the schematic of the final proposed nanofabrication process for EBL, DUV, and EUV techniques which requires no etching. As shown the left image of FIG. 14A, the photoresist (or resin) is developed on a substrate (as mentioned substrate 42 in FIGS. 3A-3B, 4A-4B, 5A-5C, 6A-6C, 7A-7C, 8A-8C, and 9A-9C). Then a metal oxide thin film (TiO2, Al2O3, HfO2), or metal (like gold, silver, aluminum, etc.) is deposited on the photoresist (or resin) as shown in the right image of FIG. 14A.

FIG. 14B illustrates the schematic of the final proposed nanofabrication process for NIL technique which requires no etching. As shown the left image of FIG. 14B, the photoresist (or resin) is cured on a substrate as mentioned substrate 42 in FIGS. 3A-3B, 4A-4B, 5A-5C, 6A-6C, 7A-7C, 8A-8C, and 9A-9C and the working stamp is demolded (left figure), a metal oxide thin film (TiO2, Al2O3, HfO2), or metal (like gold, silver, aluminum, etc.) is deposited on the resin (right figure). In this embodiment, a residual layer of the resin can exist on the substrate as shown in FIG. 14B.

FIG. 14C illustrates the schematic of the final proposed nanofabrication process for NIL technique which requires no etching. As shown the left image of FIG. 14C, the photoresist (or resin) is cured on a substrate as shown in the left image of the FIG. 14C and the working stamp is demolded as shown in the left figure of the FIG. 14C. Then a metal oxide thin film (TiO₂, Al₂O₃, HfO₂), or metal (like gold, silver, aluminum, etc.) is deposited on a substrate as mentioned substrate 42 in FIGS. 3A-3B, 4A-4B, 5A-5C, 6A-6C, 7A-7C, 8A-8C, and 9A-9C and the resin as shown in the right figure of the FIG. 14C. In this embodiment, there is no residual layer of the resin exist on the substrate as shown in FIG. 14C.

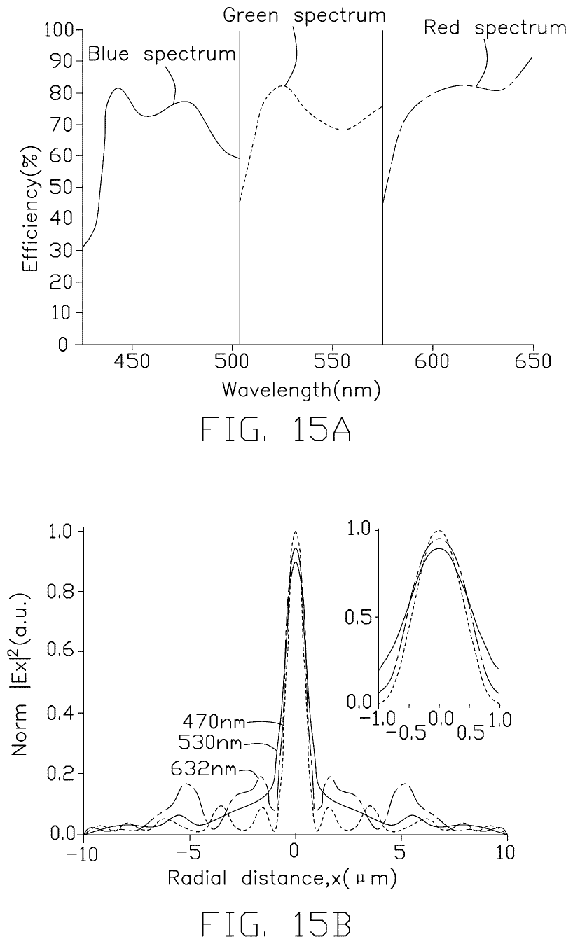

FIG. 15A shows a primarily result of the focusing efficiency for blue, green, and red spectra of the proposed nanostructures.

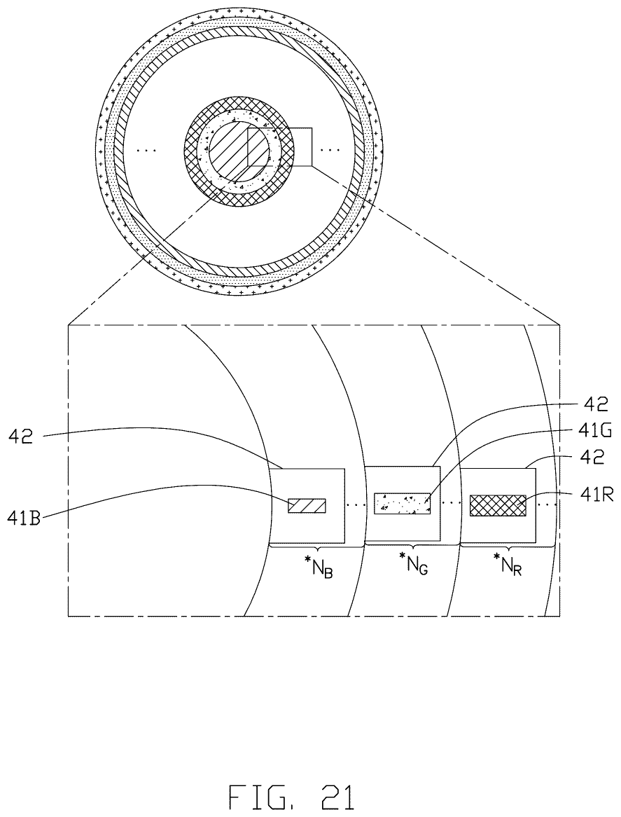

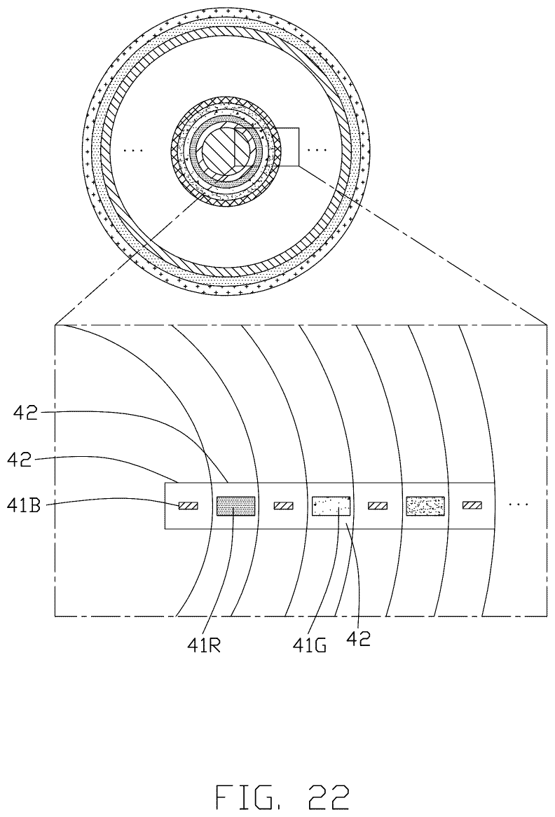

FIG. 15B. shows the intensity of the light at focusing point for blue (470 nm), green (530 nm), and red color (632 nm). As shown in FIG. 15B, shows focusing result of the plurality of an achromatic metalens presented in FIG. 21 when three different nanostructures are used, however, the method described in FIG. 22 can be also used.

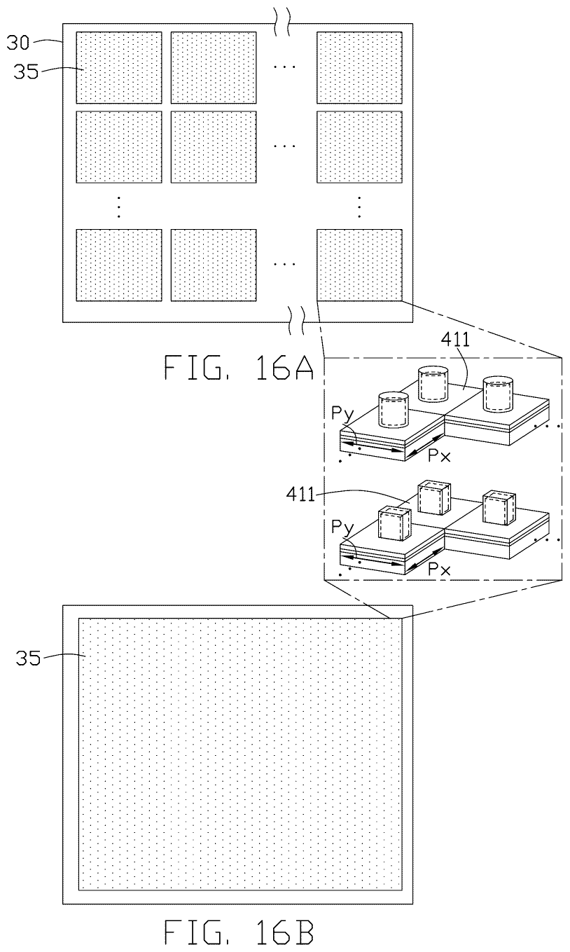

FIG. 16A illustrates some embodiments of the proposed metalens 35 in a metalens array 30 form where each metalens 35 has a rectangular shape. The nanostructures 41 can be of any presented in FIG. 10 and FIG. 13. The plurality of unit-cell nanostructures 41 could be arranged as a plurality of rectangular-shape metalenses 35 to form a metalens array 30 shown in FIG. 16A, according to one embodiment.

FIG. 16B illustrates some embodiments of the proposed metalens 35 in form of a large rectangular single metalens 35. The nanostructures 41 can be of any presented in FIG. 10 and FIG. 13. The plurality of unit-cell nanostructures 41 could be arranged as one rectangular-shape metalens with greater size shown in FIG. 16B, according to one embodiment.

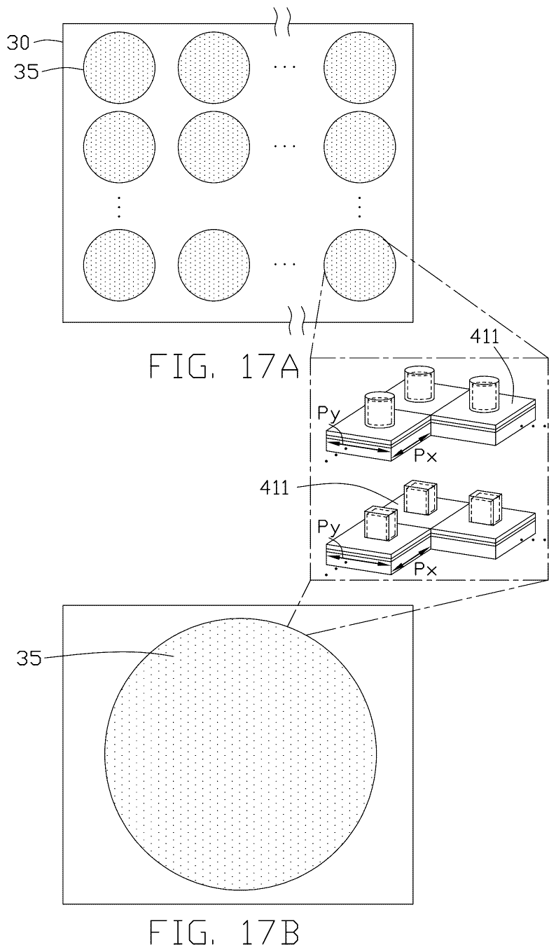

FIG. 17A illustrates some embodiments of the proposed metalens 35 in a metalens array 30 form where each metalens 35 has a circular shape. The nanostructures 41 can be of any presented in FIG. 10 and FIG. 13. The plurality of unit-cell nanostructures 41 could be arranged as a plurality of circular-shape metalenses 35 to form a metalens array 30 shown in FIG. 17A, according to one embodiment.

FIG. 17B illustrates some embodiments of the proposed metalens 35 in form of a large circular single metalens 35. The nanostructures 41 can be of any presented in FIG. 10 and FIG. 13. The plurality of unit-cell nanostructures 41 could be arranged as one circular-shape metalens 35 with greater size shown in FIG. 17B, according to one embodiment.

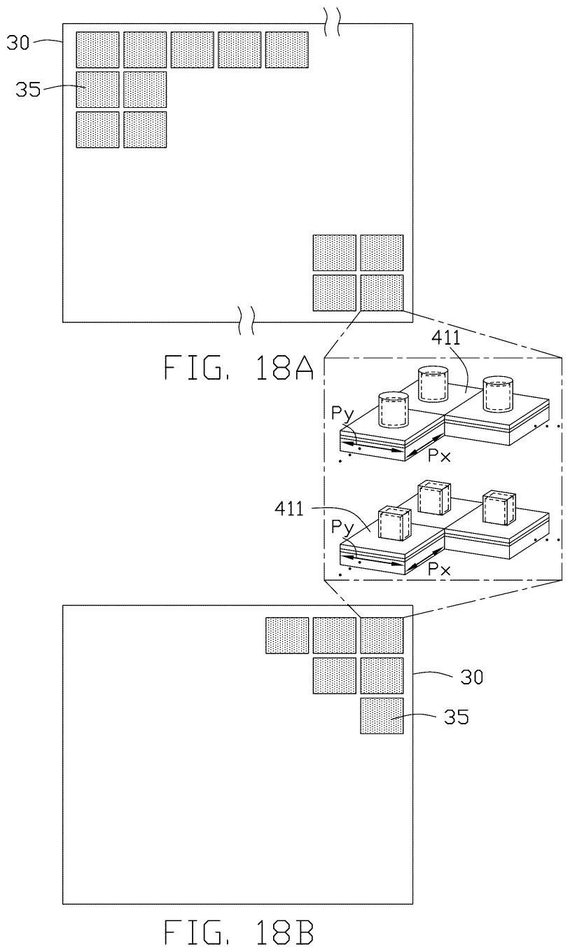

FIGS. 18A and 18B illustrate some embodiments of the proposed metalens 35 in a metalens array 30 form where the metalens array 30 has an irregular shape and can be placed at different positions. The nanostructures 41 can be of any presented in FIG. 10 and FIG. 13. The plurality of unit-cell nanostructures 41 could be arranged as a plurality of metalenses 35, and the plurality of metalenses 35 are arranged in an irregular shape and placed at different positions to form a metalens array 30 as shown in FIGS. 18A and 18B, according to one embodiment.

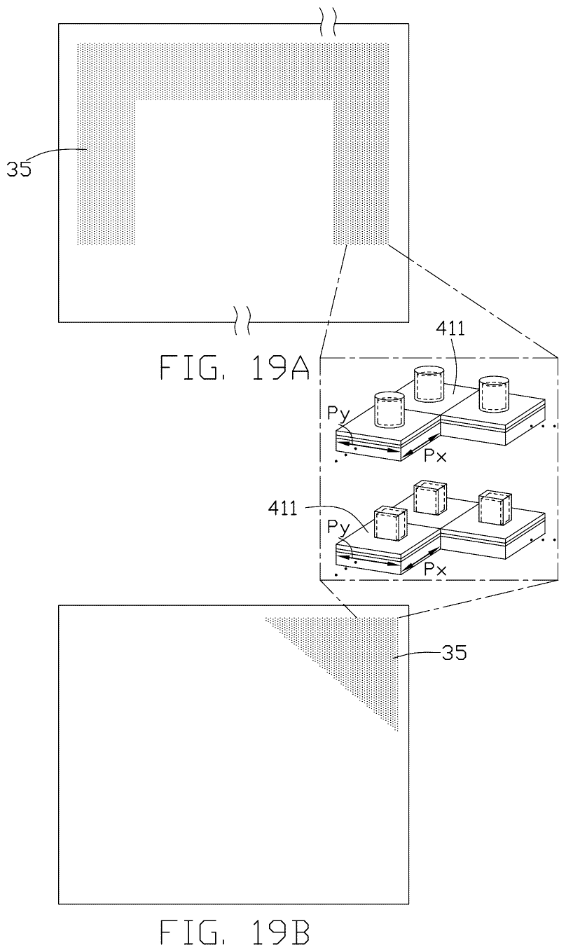

FIGS. 19A and 19B illustrate some embodiments of the proposed metalens 35 in form of an irregular shape single metalens 35 and can be placed at different positions. The nanostructures 41 can be of any presented in FIG. 10 and FIG. 13. The plurality of unit-cell nanostructures 41 could be arranged as one metalens 35, and the metalens 35 is arranged in an irregular shape and placed at different positions as shown in FIGS. 19A and 19B, according to one embodiment.

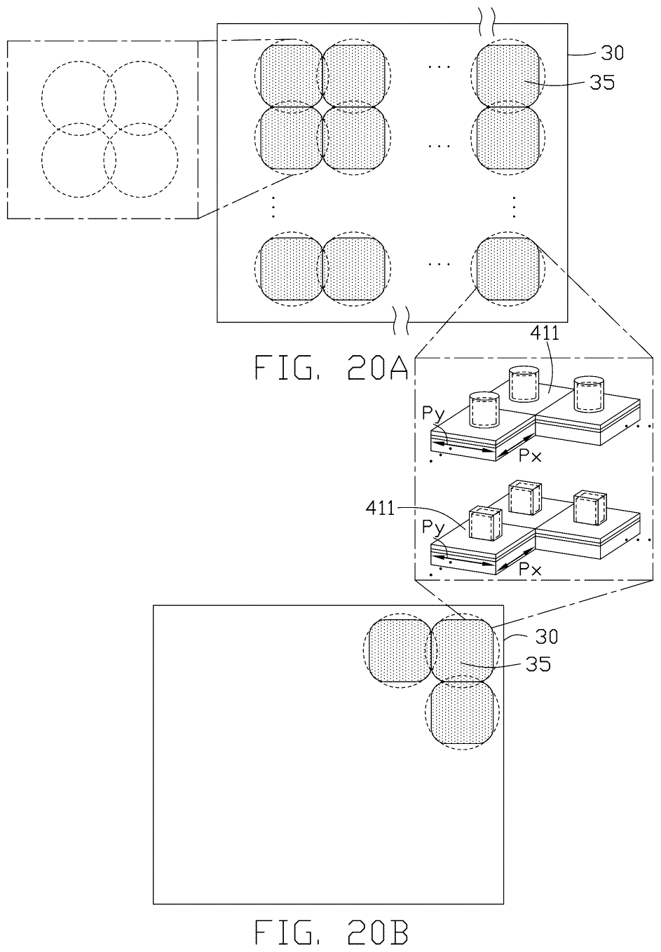

FIGS. 20A and 20B illustrate some embodiments of the proposed metalens 35 in a metalens array 30 form using overlapping metalenses 35 with different arrangement configurations. The nanostructures 41 can be of any presented in FIG. 10 and FIG. 13. The plurality of unit-cell nanostructures 41 could be arranged as a plurality of metalenses 35, and the plurality of metalenses 35 are arranged by overlapping with different arrangement configurations to form different metalens arrays 30 as shown in FIGS. 20A and 20B, according to one embodiment.

In at least one embodiment, in FIGS. 16A, 16B, 17A, 17B, 18A, 18B, 19A, 19B, 20A, 20B, the unit cells 411 may be any one of the unit cells 401, 402, 403, 404, 405, 406, 407, 408, 409, 410 as shown in FIGS. 5A, 5B, 5C, 6A, 6B, 6C, 7A, 7B, 7C, 8A, 8B, 8C, 9A, 9B, and 9C.

FIG. 21 illustrates a design of arrangement for an achromatic metalens. To obtain an achromatic metalens for light composed of three colors, there should be at least three different types of nanostructures, such as nanostructures shown in FIG. 13A and FIG. 13C except for the case when one or two types of nanostructures whose spectrum overlap between bands are used. As shown in FIG. 21, a nanostructure 41B in the unit cell shown in FIGS. 5A, 5B, 5C, 6A, 6B, 6C, 7A, 7B, 7C, 8A, 8B, 8C, 9A, 9B, and 9C for shortest wavelength (for instance blue color), a nanostructure 41G is the nanostructure in the unit cell shown in FIGS. 5A, 5B, 5C, 6A, 6B, 6C, 7A, 7B, 7C, 8A, 8B, 8C, 9A, 9B, and 9C for mid-wavelength (for instance green color), a nanostructure 41R is the nanostructure in the unit cell shown in FIGS. 5A, 5B, 5C, 6A, 6B, 6C, 7A, 7B, 7C, 8A, 8B, 8C, 9A, 9B, and 9C, for longest wavelength (for instance red color). The pitch size (Px and Py) can be similar or different for each plurality of nanostructures 41B, nanostructures 41G, and nanostructures 41R. N_{B}, N_{G}, and N_{R} are the number of unit cell for each color which can be different or similar for each color compared to other colors. For instance, when N_{B}=N_{G}=N_{R}=4, there are four rings in each step for blue, green, and red colors in a circular shape metalens which repeat the same order to the edge of the lens. In this embodiment, the arrangement is a group of 4 rings nanostructures 41B is positioned inner ring type of zone, then a group of 4 rings nanostructures 41G in the middle ring type of zone, and a group of 4 rings nanostructures 41R in the outside ring type of zone. In other embodiment, the arrangement is a group of 2 rings nanostructures 41B is positioned inner ring type of zone, then a group of 3 rings nanostructures 41G in the middle ring type of zone, and a group of 4 rings nanostructures 41R in the outside ring type of zone. The N_{B}, N_{G}, and N_{R} can be any integer. All the height of the nanostructure 41B, the nanostructure 41G and the nanostructure 41R are the same.

FIG. 22 illustrates another design of arrangement for an achromatic metalens. To obtain an achromatic metalens for three colors, there should be at least three different nanostructures, such as nanostructures shown in FIG. 13A and FIG. 13C except for the case when one or two type of nanostructures whose spectrum overlap between bands can be used. The nanostructure 41B is the nanostructure in the unit cell shown in FIGS. 5A, 5B, 5C, 6A, 6B, 6C, 7A, 7B, 7C, 8A, 8B, 8C, 9A, 9B, and 9C for shortest wavelength (for instance blue color), The nanostructure 41G is the nanostructure in the unit cell shown in FIGS. 5A, 5B, 5C, 6A, 6B, 6C, 7A, 7B, 7C, 8A, 8B, 8C, 9A, 9B, and 9C for mid-wavelength (for instance green color), The nanostructure 41R is the nanostructure in the unit cell shown in FIGS. 5A, 5B, 5C, 6A, 6B, 6C, 7A, 7B, 7C, 8A, 8B, 8C, 9A, 9B, and 9C, for longest wavelength (for instance red color). The pitch size (Px and Py) can be similar or different for each plurality of the nanostructure 41B, the nanostructure 41G, and the nanostructure 41R. The FIG. 18 shows one kind of arrangement of the nanostructure 41B, the nanostructure 41G and the nanostructure 41R. The nanostructure 41B, the nanostructure 41G and the nanostructure 41R can be changed to any types of arrangements. All the height of the nanostructure 41B, the nanostructure 41G and the nanostructure 41R are the same.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A metalens array comprising:
at least one optical transparent substrate;
a plurality of nanostructures arranged on the at least one optical transparent substrate, the plurality of nanostructures defining one or more metalenses, the one or more metalenses arranged in a predetermined arrangement; and
a thin film coating over the plurality of nanostructures.

2. The metalens array according to claim 1, wherein the one or more metalenses are arranged in a non-overlapping configuration.

3. The metalens array according to claim 1, wherein the one or more metalenses are arranged in an overlapping configuration.

4. The metalens array according to claim 1, wherein the thin film has a uniform thickness or inconsistent thicknesses that coating over the plurality of nanostructures.

5. The metalens array according to claim 1, further comprising a cladding layer coating over the thin film.

6. The metalens array according to claim 1, wherein each of the plurality of nanostructures is in an isotropic, an anisotropic, or a combination of isotropic and anisotropic shapes.

7. The metalens array according to claim 1, wherein the plurality of nanostructures are in a same shape and arranged in different geometrical phases.

8. The metalens array according to claim 1, wherein the plurality of nanostructures are in a same shape but with different sizes.

9. The metalens array according to claim 1, wherein the plurality of nanostructures are in different shapes and different sizes.

10. The metalens array according to claim 1, wherein a transparent rate of the thin film is greater than a transparent rate of the plurality of nanostructures.

11. A display device comprising:
a micro display configured to emit lights;
at least one metalens array spaced apart from the micro display, the at least one metalens array configured to transmit the lights emitted by the micro display, the at least one metalens array comprising:
at least one optical transparent substrate;
a plurality of nanostructures arranged on the at least one optical transparent substrate, the plurality of nanostructures defining one or more metalenses, the one or more metalenses arranged in a predetermined arrangement; and
a thin film coating over the plurality of nanostructures.

12. The display device according to claim 11, wherein the one or more metalenses are arranged in non-overlapping configuration.

13. The display device according to claim 11, wherein the one or more metalenses are arranged in an overlapping configuration.

14. The display device according to claim 11, wherein the thin film has a uniform thickness or inconsistent thicknesses that coating over the plurality of nanostructures.

15. The display device according to claim 11, wherein the metalens array further comprises a cladding layer coating over the thin film.

16. The display device according to claim 11, wherein each of the plurality of nanostructures is in an isotropic, an anisotropic, or a combination of isotropic and anisotropic shapes.

17. The display device according to claim 11, wherein the plurality of nanostructures are in a same shape and arranged in different geometrical phases.

18. The display device according to claim 11, wherein the plurality of nanostructures are in a same shape but with different sizes.

19. The display device according to claim 11, wherein the plurality of nanostructures are in different shapes and different sizes.

20. The display device according to claim 11, wherein a transparent rate of the thin film is greater than a transparent rate of the plurality of nanostructures.
